(19) United States
(12) Patent Application Publication
(10) Pub. No.: US 2008/0319862 A1
(43) Pub. Date: Dec. 25, 2008

(54) METHOD AND SYSTEM FOR PREVENTING AD STRIPPING FROM AD-SUPPORTED DIGITAL CONTENT

(75) Inventors: Ronny GOLAN, Tel Aviv (IL); Ariel Napchi, Tel Aviv (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: HIROMEDIA LTD., Tel Aviv (IL)

(21) Appl. No.: 12/203,936

(22) Filed: Sep. 4, 2008

Related U.S. Application Data
(63) Continuation-in-part of application No. 11/194,649, filed on Aug. 2, 2005.
(60) Provisional application No. 60/599,876, filed on Aug. 10, 2004.

(51) Int. Cl. G06Q 30/00; G06F 15/16

(52) U.S. Cl. 705/14; 709/202

(57) ABSTRACT

Methods for preventing ad stripping from ad-supported digital content include removing part of the content, and using a digital rights management (DRM) proxy server to provide links to any removed content part and to ads to be inserted in the content to a player who plays the content with the ads. The DRM proxy server ensures that the player cannot distinguish between removed content parts and the ads. A system enabling the method includes in addition to the DRM server and player an encoder used to remove at least one part from the content, encode the remaining content and the removed part and supplying links to each removed part to the DRM proxy server. The system further includes an ad server used to provide links to ads to the DRM proxy server.

### CROSS REFERENCE TO RELATED APPLICATIONS

The present invention is a Continuation in Part of U.S. patent application Ser. No. 11/194,649 filed Aug. 2, 2005, which claims priority from U.S. Provisional Application No. 60/599,876, filed Aug. 10, 2004, both of which are incorporated herein by reference in their entirety.

### FIELD OF THE INVENTION

The present invention relates in general to ad supported content Digital Rights Management (DRM), and more particularly to the prevention of ad stripping from ad-supported content.

### BACKGROUND OF THE INVENTION

The past few years have witnessed the development of many software (SW) applications which aim to remove advertisements (ads) from digital content, for example from Internet pages, streaming video such as Internet protocol TV (IPTV), streaming audio, downloaded video, downloaded audio and the like. An exemplary such application is “AdBlock plus” (an open-source project). These SW applications detect the ad calls done by a browser (or a player) and block them. In the current architecture of the Internet, the content is called from one source (e.g. a content server) and the ads are called from a separate “ad” server. That is, an ad server receives the request for an ad directly from the browser/player and returns to the browser/player a link to the most relevant ad. It is therefore easy to detect the ad calls and block them, and therefore easy to show the content without the ads. Even if the content (e.g. a video stream) and the ads are held on the same servers, it is easy to detect the ad calls, since the ads are stored in a different file than the video stream in order to allow the insertion of personalized dynamic ads. Furthermore, since many computer games and other SW applications are distributed with personalized dynamic ads (for example: companies like Massive and Double-fusion create ad-supported games), it is possible that hackers will also try to remove these ads.

It would therefore be advantageous to have a method and system which prevent ad stripping from ad-supported digital content.

### SUMMARY OF THE INVENTION

The invention provides a method and system for preventing hacking of content, specifically the removal of ads from ad-supported digital content. In this specification, “digital content” refers to data streams, downloaded audio and video content, Internet pages, computer games, SW applications and the like. Hereinafter, content is also referred to interchangeably as a “content piece”, “content file” or just “file”. The removal of ads from digital content is prevented by ensuring that anyone who tries to remove the ads will end up removing parts of the content as well, thus harming a user's viewing experience.

The invention provides security features to prevent hacking. These features include treating parts of the content as if they were ads and adding them to the content in real time, when the content is actually viewed by a user. The content is encoded in a way such that a certain percentage (part) of it is removed and saved separately. Hereinafter, a part of content removed from a given content piece is referred to as a “missing part”. Ads may be stored on a separate ad server or anywhere on the network. Whenever an ad or a missing part needs to be called, a player calls a proxy server (called herein a “digital rights management proxy server” or “DRM proxy server”) instead of making a direct call to the ad server.

In this specification, a “player” may be any software that runs on a user device and enables the user to use the content. Examples of a “player” include a Web browser, a multimedia player or a dedicated SW application or computer game which includes ads. The multimedia player may be either a dedicated video/audio player or any existing player (Windows Media Player, Flash Player etc.) with a special “plug in” which knows how to treat the ads/missing parts and play them correctly. Further, the word “player” may typically represents several different players, Web browsers, etc. for different content types (video, audio, pictures, text, SW etc.), in addition to referring to a single player. The description continues with reference to video as a given content piece (and therefore to a video player) by way of example only.

The DRM proxy server holds the information on when it should call an ad and when it should call a missing part. The player is unaware of this information. The DRM proxy server decides whether it is required to serve an ad or a missing part or both. The DRM proxy server holds information and links to the missing part(s) and in case an ad needs to be called, the DRM proxy server calls the ad server and gets from the ad server a link to the appropriate ad. Each link is passed to the player. A user who has installed an ad-blocker will therefore see the content without the missing part(s) and will have a bad viewing experience. When the content is viewed together with the missing part(s) and ads, a player cannot differentiate between the ads and missing part(s) (and therefore a user who tries to temper with the player and remove the ads will not be able to differentiate between the ads and missing parts and remove only the ads), these being “seamlessly” combined with the rest of the original content. Consequently, ad stripping from ad-supported digital content is prevented as it will result in the user viewing only part of the video.

In an embodiment, the invention provides a method for preventing ad stripping from ad-supported digital content comprising the steps of, at a DRM proxy server: receiving a link to at least one missing part related to a given content; receiving, from a player, a call for a link to each at least one missing part related to the given content and a call for a link to each at least one ad that needs to be shown in the given content; receiving the link to each at least one ad; and passing the link to each at least one ad and the link to each at least one missing part to the player, thereby enabling the player to play the given content in a complete form including missing parts and ads. We note that in this application, actions involving the DRM proxy server and reciting links to ads and missing parts may, in some embodiments, refer to the ads and missing parts themselves. Thus, in some embodiments of the method, the DRM proxy server may receive a missing part instead of a link to the missing part. In some embodiments of the method, the DRM proxy server may receive from a player a call for missing parts and ads themselves instead of calls for links to the missing parts and ads. In some embodiments of the method, the DRM proxy server may receive ads instead of links to ads. In some embodiments of the method, the DRM proxy server may pass the ads and the missing parts to the player instead of passing the links to ads and missing parts. Therefore, it is to be understood that recitation of “links to ads and missing parts” may refer in some cases to the ads and missing parts themselves.

### BRIEF DESCRIPTION OF THE DRAWINGS

For a better understanding of the present invention and to show more clearly how it could be applied, reference will now be made, by way of example only, to the accompanying drawings in which:

FIG. 1 shows a block diagram of an embodiment of a system of the invention;

FIG. 2 shows a flow chart of steps performed by the DRM proxy server in an embodiment of a method of the invention.

### DETAILED DESCRIPTION OF THE INVENTION

This description uses digital video files as exemplary of digital content. It should be apparent to one skilled in the art that the description applies equally well to all other types of content as defined above.

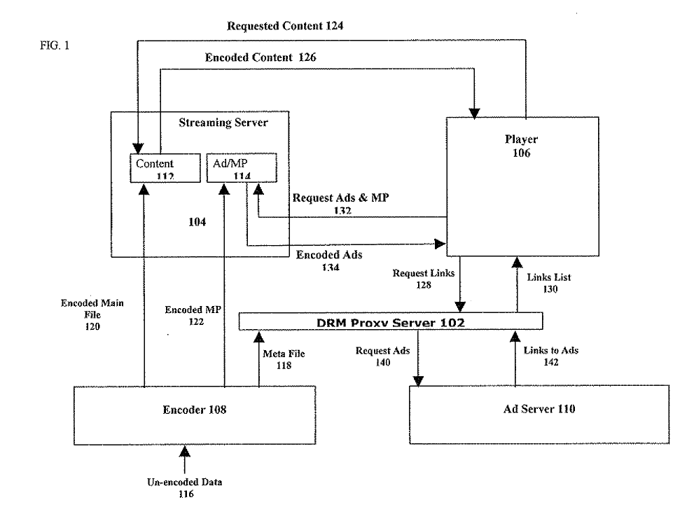

FIG. 1 shows a preferred embodiment of a system 100 for preventing ad striping from digital content according to the present invention. System 100 includes a DRM proxy server 102, a streaming server 104, a player 106, an encoder 108 and an ad server 110. Streaming server 104 includes a content server 112 and an ads/missing parts (“Ad/MP”) server 114. In some embodiments, the DRM proxy server, the streaming server and the ad server may be located on the same physical unit. In some embodiments the ad server may be a part of the DRM proxy server.

The DRM proxy server is responsible for masking (from the player) the information that distinguishes between ads and missing parts. All ad calls are done through the DRM proxy server and cannot be differentiated from similar calls for missing parts. The DRM proxy server is the only component in the system that can differentiate between ads and missing parts. In other words, the main function of the DRM proxy server is to ensure that both calls for ads and missing parts as well as the ads and the missing parts themselves are indistinguishable to the player (e.g. the calls and the files themselves do not include information that can easily allow a user to know whether the call is for an ad or for a missing part). This will prevent a user from building a player that can play the content without the missing parts.

Streaming server 104 is used for streaming content and (through the Ad/MP server) is responsible for streaming the ads and the missing parts to the player. The streaming server can be a single server, a CDN (Content Distribution Network), a P2P (Peer-to-Peer) streaming server, a P2P network, a multicast server and the like. In a download environment, the streaming server is responsible for passing the content, ads and missing parts to a player on the user device. In some embodiments, the streaming server may also hold tags on where the ads and missing parts should be inserted in the content file and pass this information to the player. A tag could be a time stamp in the case of audio and video files, a location in the page in the case of an HTML file, or a specific API (Application Programming Interface) in the case of a SW application.

In use, player 106 receives relevant links from the DRM proxy server and calls the ads and missing parts in the appropriate places from a streaming server or from a local storage on the user device. Since the information that distinguishes between calls for ads and for missing parts does not exist on the user device, a hacker who tries to tamper with these calls or with the ads/missing parts files will end up watching the video/audio or web page without some parts (the missing parts).

Encoder 108 is responsible for removing the missing parts from the original content file, for passing the content and missing parts to be stored on the streaming server and for providing a meta-file to the DRM proxy server or the content server. The metafile includes tags on the place(s) within the encoded file where the missing parts should enter and the links to the actual files. In case of a SW application, the “encoding” may be done manually by programmers, who may remove pieces of code, images, videos or any other type of content similar to the ads that appear in the application from the SW and pass the meta file (which in this case may not require to include information on the location within the main file) to the DRM proxy server or the content server.

Ad server 110 serves to personalize the ads and to decide on the best ad to be shown to the user. In this invention, all ad calls come from the DRM proxy server to prevent the player from distinguishing between the missing parts and the ads. This contrasts with the known art in the current architecture of the Internet, where an ad server receives ad calls directly from the player and returns to the player links to the relevant ads.

In typical use, with further reference to FIG. 1, encoder 108 receives an un-encoded digital content file 116 and encodes the file into a special format known by the player. The encoder removes sections from the original file (these becoming the “missing parts”) and creates a meta-file 118 with tags where the ads and missing parts should be inserted. The meta-file also includes the links to the actual missing parts. The encoder may further encrypt the data if necessary, marks the file as an encoded file, optionally provides a unique identification (ID) to the file and outputs the following: meta-file 118 passed to the DRM proxy server, which stores it for future calls; an encoded main file (without the missing parts) 120, passed to the content server 112; and an encoded missing parts output 122, passed and stored on Ad/MP server 114.

In the case of video, the encoder can also remove parts from each frame (for example the lower third of the frame) in a way that will afterwards allow adding banners in place of the removed parts and keep the same protection as for video ads (e.g. while playing the video, the player can either add a “missing lower third of the video” or insert there a banner instead).

Streaming server 104 receives the encoded main file (without the missing parts) from the encoder and a content request 124 from player 106. Request 124 commands server 102 to start streaming or downloading the content.

Player 106 receives content file 126 from server 102 and receives from either server or from the DRM proxy server the tags (without any information that distinguishes between an ad and a missing part). If the player is a SW application, the SW application may already include the APIs that call the DRM proxy server in order to get the ads or missing parts. The call to the DRM proxy server may be done in two ways:

1. The player calls the DRM proxy server at the beginning of the video to request all the links to the ads and the missing parts, and thereafter plays the video with the appropriate calls to the ads/missing parts server each time an ad or a missing part needs to be played.

2. The player receives from the content server or the DRM proxy server the tags, and calls the DRM proxy server and requests the appropriate file each time an ad or a missing part needs to be called. The DRM proxy server then returns a link to the appropriate file.

The player then sends a request 128 to the DRM proxy server for links to the missing parts and ads, and receives in return from the DRM proxy server a list of links 130 to the ads/missing parts. The links could be sent at one time for the whole video or per ad/missing part. The player also receives a stream of encoded ads/missing parts 132 from the Ad/MP server, sent in response to a request 134 for such parts. The player plays the streamed content file and each time there is a need to play an ad or a missing part (according to the information received from the DRM proxy server or from the content server) it requests a link from link list 130. The player then sends a request 132 to receive from the Ad/MP server the appropriate file parts (ads or missing parts) 134. A hacker who will try to block these calls will end up watching only a part of the video as the missing parts will not be shown.

The player needs to fill the video buffers with data from the different sources so that the transition between the main video and the ads or missing parts is flawless and seamless. This can be done exemplarily as follows: the player can pre-fetch the ads/missing parts in order to make sure the video and audio buffers axe always filled with the appropriate information and enable a seamless transition. When the video file is being loaded, the player may also calculate the total length of the video file (which includes the main video file plus the missing parts plus all the ads) and present it to the user in order to give accurate information regarding the video's length.

DRM Proxy server 106 receives as inputs meta-file 118, request 128 for a link to the missing parts and ads from the player, and a link to ads 142 received in response to a request 140 from the ad server that returns the links to the appropriate ads for the content. Either at the beginning of the video stream or each time an ad or a missing part should be called, the player calls the DRM proxy server and requests the link to the appropriate files. The DRM proxy server knows whether it needs to return an ad or a missing part. If there is a need to return a missing part, the DRM proxy server sends a link to the appropriate missing part file. After receiving response 142, the DRM proxy server passes the link to the appropriate ad file to the player.

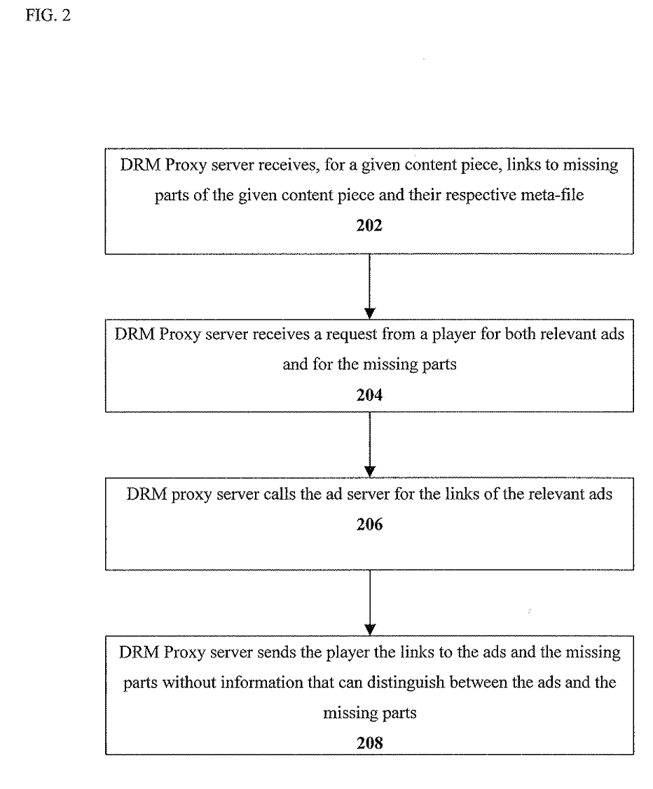

FIG. 2 shows a flow chart of steps performed by the DRM proxy server in an embodiment of a method of the invention. In a step 202, the DRM proxy server gets from the encoder the meta-file which includes links to missing parts related to a given content piece. The missing parts themselves can be hosted anywhere as long as the DRM proxy server has information on where they are stored. In some embodiments, the information included in the meta-file could come separately from different sources.

In step 204, the DRM proxy server gets a request from the player, directly or indirectly, for ads and/or missing parts.

In step 206, the DRM proxy server calls the ad server to get the links for the relevant ads. At this point, the DRM proxy server holds all the information on the ads and missing parts that need to be sent to the player.

In step 208 the DRM proxy server passes a list of links to ads/missing parts to the player. The DRM proxy server masks the information that distinguishes between the ads and the missing parts in order to prevent hackers from building a player that removes the ads without harming the content.

All patents and patent applications mentioned in this specification are herein incorporated in their entirety by reference into the specification, to the same extent as if each individual patent or patent application was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made.

1. A method for preventing ad stripping from ad-supported digital content comprising the steps of: at a digital rights management (DRM) proxy server:
a) receiving a link to each missing part related to a given content;
b) receiving, from a player, a call for a link to each missing part related to the given content and a call for a link to each ad that needs to be shown in the given content;
c) receiving the link to each ad; and
d) passing the link to each ad and the link to each missing part to the player, thereby enabling the player to play the given content in a complete form including missing parts and ads.

2. The method of claim 1, wherein the step of passing the link to each ad and the link to each missing part to the player includes masking any difference between each ad and each missing part.

3. The method of claim 1, wherein the step of receiving a call for a link to each missing part includes receiving a call for each missing part itself and wherein the step of passing the link to each missing part includes passing each missing part to the player.

4. The method of claim 1, wherein the step of receiving a call for a link to ad includes receiving a call for ad itself and wherein the step of passing the link to each ad includes passing each ad to the player.

5. The method of claim 1, wherein the player is selected from the group consisting of a video player, an audio player, a Web browser, a multimedia player, a dedicated software application which includes ads and a computer game which includes ads.

6. The method of claim 1, wherein the step of receiving the link to each ad includes receiving the link to each ad from an ad server.

7. The method of claim 1, wherein the given content is streamed.

8. A method for preventing ad stripping from ad-supported digital content, wherein a given content is divided and encoded into a main part and at least one missing part in a given format to a player, the method comprising the steps of:
a) providing a digital rights management (DRM) proxy server; and
b) in response to calls from the player for ads and missing parts, using the DRM proxy server to provide the player a respective link to each ad and each missing part such that the links to the ads and the missing parts are indistinguishable to the player;
whereby the player receives the main part and the links to ads and missing parts and plays the given content in a complete form including missing parts and ads.

9. The method of claim 8, wherein the step of using the DRM proxy server to provide the player a respective link to each ad and each missing part such that the links to the ads and the missing parts are indistinguishable to the player includes using the DRM proxy server to provide the player each ad and each missing part such that the ads and the missing parts are indistinguishable to the player.

10. The method of claim 8, wherein the step of using the DRM proxy server to provide the player a respective link to each ad and each missing part such that the links to the ads and the missing parts are indistinguishable to the player is preceded by the step of, by the DRM proxy server, receiving a link to each missing part of the given content.

11. The method of claim 9, wherein using the DRM proxy server to provide the player each ad and each missing part such that the ads and the missing parts are indistinguishable to the player is preceded by the step of, by the DRM proxy server, receiving the respective missing parts of the given content.

12. The method of claim 10, wherein the receiving a link to each missing part of the given content includes receiving a meta-file related to the given content, which meta-file includes a link to each missing parts.

13. The method of claim 9, wherein the using the DRM proxy server to provide the player each ad and each missing part such that the ads and the missing parts are indistinguishable to the player includes providing an ad received from an ad server.

14. The method of claim 8, wherein the player is selected from the group consisting of a video player, an audio player, a Web browser, a multimedia player, a dedicated software application which includes ads and a computer game which includes ads.

15. The method of claim 8, wherein the given content is streamed.

16. A system for preventing ad stripping from ad-supported digital content played by a player, comprising:
a) an encoder used to split a given content into a main part and at least one missing part and to provide the main part and each missing part in a given format to the player; and
b) a digital rights management (DRM) proxy server in operative communication with the player, with the encoder and with an ad server and used for rendering calls for ads and missing parts indistinguishable to the player.

17. The system of claim 16, further comprising a content server for storing the main part and each missing part.

18. The system of claim 16, wherein the DRM proxy server is used for rendering ads and missing parts indistinguishable to the player.
